(19) United States
(12) Patent Application Publication
(10) Pub. No.: US 2021/0055184 A1
(43) Pub. Date: Feb. 25, 2021

(54) SYSTEM FOR DEFINING MULTI-LAYERED STRUCTURES

(71) Applicant: The Goodyear Tire & Rubber Company, Akron, OH (US)

(72) Inventors: Md Atiqur Rahman Bhuiyan, Copley, OH (US); Blake Edward Matthies, Akron, OH (US); Gregory Monroe Bond, Akron, OH (US); Stephen Michael Pavelschak, Ravenna, OH (US); Jimmy Lee Richards, Rootstown, OH (US); Francesco Sportelli, Bettembourg (LU); Marc Borowczak, Hartville, OH (US)

(21) Appl. No.: 16/547,684

(22) Filed: Aug. 22, 2019

(51) Int. Cl. G01M 17/02; G01B 11/16; G01M 5/00; G01N 3/24

(52) U.S. Cl. CPC G01M 17/02; G01N 3/24; G01M 5/0041; G01B 11/16

(57) ABSTRACT

A system determines average values for bending stiffness and shear rigidity of a shear band coupon. The system includes: application of multiple, different loads to a midpoint of a first span length of the shear band coupon; determining the deflection of the first span length at each of the multiple loads; application of the same multiple, different loads to a midpoint of a second longer span length of the shear band coupon; determining the deflection of the second span length at each of the multiple loads; determining the bending stiffness at each multiple load from the deflection of the first and second span lengths at each multiple load; averaging the bending stiffnesses at each load to determine an average overall bending stiffness of the shear band coupon; determining the shear rigidity at each multiple load from the deflection of the first and second span lengths at each multiple load; and averaging the shear rigidities at each load to determine an average overall shear rigidity of the shear band coupon.

### FIELD OF THE INVENTION

The present invention provides a system for defining multi-layered structures and, more specifically, for determining an average overall bending stiffness and an average overall shear rigidity of multi-layered structures.

### BACKGROUND OF THE INVENTION

Those skilled in the art of pneumatic and non-pneumatic tires have developed a wealth of experience in adapting the tire construction to achieve a variety of performance combinations for tread wear, handling, wet and dry traction, rolling resistance, etc. As an example of this adaptation, a pneumatic or non-pneumatic tire may be optimized for low weight and low hysteresis which results in improved rolling resistance and improved fuel economy. For example, tire designers frequently try to minimize the weight and hysteresis of the materials that constitute the tire.

Non-pneumatic or structurally supported tires may support a load without internal air pressure. Such an example non-pneumatic tire may include a ground contacting portion and side wall portions that extend radially inward from the tread portion and anchor in bead portions that are adapted to remain secure to a wheel during rotation of the tire. A reinforced annular band, or “shear” band, may be disposed radially inward of the tread portion. This shear band may include at least one shear layer, a first membrane adhered to the radially inward extent of the shear layer and a second membrane adhered to the radially outward extent of the shear layer.

Another example non-pneumatic tire may include an outer annular shear band and a plurality of web spokes that extend transversely across and radially inward from the annular band and are anchored in a wheel or hub. The annular shear band may further comprise a shear layer, at least a first membrane adhered to the radially inward extent of the shear layer, and at least a second membrane adhered to the radially outward extent of the shear layer.

As described above for the exemplary tires, both may use an annular shear band comprising a shear layer to provide desirable performance benefits in a tire. The shear layer may include an elastomeric material such as natural or synthetic rubber or polyurethane. However, these materials have proven to create more hysteresis and add more weight than desirable, which may result in a tire having a higher rolling resistance. Accordingly, there is a need for an improved shear layer construction that satisfies the aforementioned need without compromising the shear modulus and shear strains needed in the shear layer for the tire to function satisfactorily. As described below, Applicant has discovered an advantageous system for testing the shear layer and providing lower weight and hysteresis without compromising other properties of the shear layer. This improved system may apply to pneumatic tires, non-pneumatic tires, hybrid tires operating at reduced inflation pressure in conjunction with structural support from the annular band, and other products as well.

### SUMMARY OF THE INVENTION

A system in accordance with the present invention determines average values for bending stiffness and shear rigidity of a shear band coupon. The system includes: application of multiple, different loads to a midpoint of a first span length of the shear band coupon; determining the deflection of the first span length at each of the multiple loads; application of the same multiple, different loads to a midpoint of a second longer span length of the shear band coupon; determining the deflection of the second span length at each of the multiple loads; determining the bending stiffness at each multiple load from the deflection of the first and second span lengths at each multiple load; averaging the bending stiffnesses at each load to determine an average overall bending stiffness of the shear band coupon; determining the shear rigidity at each multiple load from the deflection of the first and second span lengths at each multiple load; and averaging the shear rigidities at each load to determine an average overall shear rigidity of the shear band coupon.

According to another aspect of the system, the shear band coupon has layers of lightweight composite materials.

According to still another aspect of the system, a fixture accommodates the shear band coupon during load application.

According to yet another aspect of the system, a laser sensor for measuring the deflections of the first and second lengths under each of the multiple loads.

According to still another aspect of the system, the shear band coupon has wire band facing sheets and a rubber compound core.

According to yet another aspect of the system, the shear band coupon has entirely metal facing sheets and a rubber compound core.

According to still another aspect of the system, the shear band coupon has wire band facing sheets and a 3D spacer fabric core with a rubber layer at sides of the shear band coupon.

According to yet another aspect of the system, the shear band coupon has wire band facing sheets and a 3D spacer fabric core without a rubber layer at sides of the shear band coupon.

According to still another aspect of the system, the shear band coupon has a 610 mm length, a 102 mm width, and a 12 mm thickness.

According to yet another aspect of the system, the shear band coupon has a 670 mm length, a 38 mm width, and a 5 mm thickness.

A fixture determines average values for bending stiffness and shear rigidity of a shear band coupon. The fixture includes two support bars, a device for applying a vertical load to a mid-point location on the shear band coupon equidistant from each support bar; and a laser sensor. The support bars are adjustable to vary a distance from one support bar to the other support bar. The laser sensor measures the vertical deflection of the mid-point location. Multiple, different loads are applied by the device to a midpoint of a first span length of the shear band coupon and a different second span length of the shear band coupon. Deflections of the midpoint are used to determine an average overall bending stiffness of the shear band coupon and an average overall shear rigidity of the shear band coupon.

According to another aspect of the fixture, the shear band coupon has layers of lightweight composite materials.

According to still another aspect of the fixture, the laser sensor measures the deflections of the first and second span lengths under each of the multiple loads.

According to yet another aspect of the fixture, the shear band coupon has wire band facing sheets and a rubber compound core.

According to still another aspect of the fixture, the shear band coupon has entirely metal facing sheets and a rubber compound core.

According to yet another aspect of the fixture, the shear band coupon has wire band facing sheets and a 3D spacer fabric core with a rubber layer at sides of the shear band coupon.

According to still another aspect of the fixture, the shear band coupon has wire band facing sheets and a 3D spacer fabric core without a rubber layer at sides of the shear band coupon.

According to yet another aspect of the fixture, the shear band coupon has a 610 mm length, a 102 mm width, and a 12 mm thickness.

According to still another aspect of the fixture, the shear band coupon has a 670 mm length, a 38 mm width, and a 5 mm thickness.

According to yet another aspect of the fixture, the first and second span lengths are determined by a first and a second distance, respectively, between the support bars.

### Definitions

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Contact Pressure” means the average contact pressure for contact area C created by a tire loaded against the ground or other supporting surface and may be calculated as the quotient of load L divided by the contact area C.

“Cord” means one of the reinforcement strands, including fibers, which are used to reinforce the plies.

“Equatorial Plane” means a plane that passes perpendicular to the tire axis of rotation and bisects the tire structure.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Laminate structure” means an unvulcanized structure made of one or more layers of tire or elastomer components such as the innerliner, sidewalls, and optional ply layer.

“Meridian Plane” means a plane that passes through and includes the axis of rotation of the tire.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Secant vertical stiffness” is an example of a mathematical relationship defining vertical stiffness as the quotient of L/f or the load L placed on the tire divided by the deflection f of the tire.

“Sidewall” means a portion of a tire between the tread and the bead.

“Tangent vertical stiffness” is another example of a mathematical relationship defining vertical stiffness as the slope of a line tangent to a curve created by plotting load L as a function of deflection f for a given tire containing a shear band at a target load or deflection.

### BRIEF DESCRIPTION OF THE DRAWINGS

The present invention will be described by way of example and with reference to the accompanying drawings in which:

FIG. 1 is a schematic view in the equatorial plane of an example tire for use with the present invention under load.

FIG. 2 is a schematic view in the meridian plane of an example loaded shear band as used in the tire of FIG. 1.

FIG. 3 is a schematic view in the meridian plane of another example shear band for use with the present invention. The shear band has five reinforcement layers i.e., three reinforcement layers are added between the innermost and outermost reinforcement layers.

FIG. 4 is a schematic view of the loading of an example shear band in accordance with the present invention.

FIG. 5 is an example load versus displacement curve for multiple span lengths.

FIG. 6 is an example chart of bending stiffnesses determined by the experimental system.

FIG. 7 is an example bending stiffness versus span length/thickness curve generated from FIG. 6.

FIG. 8 is an example chart of bending and shear stiffnesses determined by the analytical system.

FIG. 9 is an example deflection versus span length curve generated from FIG. 8.

FIG. 10 is an example load versus displacement determined by the system of the present invention.

FIG. 11 is an example chart of bending and shear stiffnesses determined by the system of the present invention.

FIG. 12 is an example chart of bending and shear stiffnesses determined by the system of the present invention.

FIG. 13 is a schematic diagram of the system of the present invention.

Similar numerals refer to similar parts throughout the drawings.

### DETAILED DESCRIPTION OF EXAMPLES OF THE INVENTION

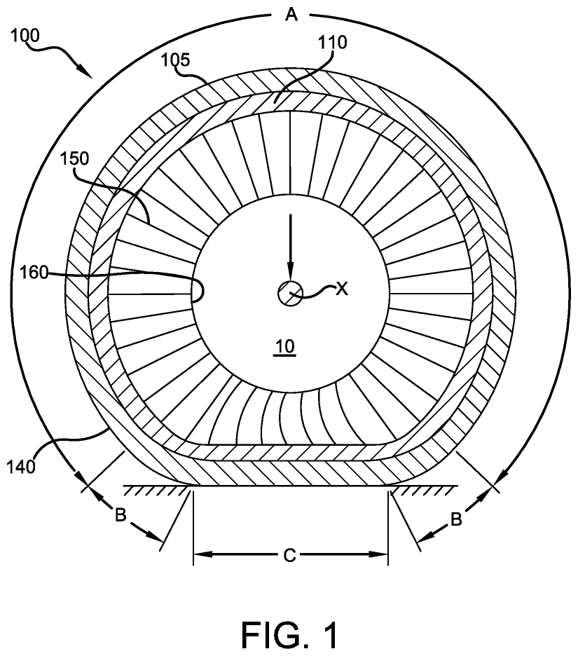

FIGS. 1-2 schematically show an example wheel/tire 100 for use with the present invention. The wheel/tire 100 may include a tread portion 105, a hub 10, multiple web spokes 150, and a ring-shaped shear band 110. Reducing the radial thickness of the shear band 110 may adversely impact the performance of the wheel/tire 100. More specifically, reducing the radial thickness of shear band 110 may decrease the band's stiffness and increase the potential for peak to peak radial displacement during operation.

The web spokes 150 may comprise tension transmitting elements extending transversely axially across and radially inward from the shear band 110. A mounting band 160 may be disposed at the radially inner end of the web spokes 150. The mounting band 160 may anchor the wheel/tire 100 to the hub 10. The tread portion 105 may be formed at the outer periphery of the shear band 110 and may include grooves or ribs thereon.

FIG. 2 shows the example wheel/tire 100 in section view in the meridian plane (but without the tread portion 105). The reinforced shear band 110 may include a shear layer 120, an innermost first reinforcement layer 130 adhered to the radially innermost extent of the shear layer 120, and an outermost second reinforcement layer 140 adhered to the radially outermost extent of the shear layer 120. The reinforcement layers 130, 140 may have a tensile stiffness greater than the shear stiffness of the shear layer 120 such that the shear band 110 undergoes shear deformation under a circumferential load. More specifically, when the ratio of the elastic modulus of the reinforcement layers 130, 140 to the shear modulus of the shear layer 120 is relatively low, deformation of the shear band 110 under load may approximate that of a homogenous band and may produce a non-uniform ground contact pressure. Conversely, when this ratio is sufficiently high, deformation of the shear band 110 under load may be essentially pure shear deformation of the shear layer 120 with little longitudinal extension or compression of the reinforcement layers 130, 140.

As indicated in FIG. 1, a load L placed on the axis of rotation X may be transmitted by tension in the web spokes 150 to the shear band 110. The annular shear band 110 may act in a manner similar to an arch exhibiting a circumferential compression and a longitudinal bending stiffness in the tire equatorial plane sufficiently high to act as a load-supporting member. Under load, the shear band 110 may deform in a ground contact area C with the ground surface through shear deformation of the shear band 110. The ability to deform through shear may thus provide a compliant ground contact area C similar to that of a pneumatic tire, with similarly advantageous results.

More specifically, a region A of the annular band 110, that is, the portion not in ground contact, may act like an arch with the web spokes 150 in tension. The load L on the wheel/tire 100, transmitted from a vehicle (not shown) to the hub 10 may essentially hang from the arch region A. The web spokes 150 in two transition regions B and the contact area C may not be in tension. The web spokes 150 may be relatively thin and may not provide more than an insignificant vertical load bearing force. As the wheel/tire 100 rotates, the arch region A of the annular band 110 may continually change.

The shear layer 120 may be constructed from a material having a shear modulus of about 3.0 MPa to about 20.0 MPa. Such materials may include natural and synthetic rubbers, polyurethanes, foamed rubbers and polyurethanes, segmented copolyesters, and/or block co-polymers of nylon. The first and second reinforcement layers 130, 140 may include inextensible cord reinforcements embedded in an elastomeric coating (e.g., a belt structure for a pneumatic tire). The reinforcement layers 130, 140 may be adhered to the shear layer 120 by cured elastomeric materials.

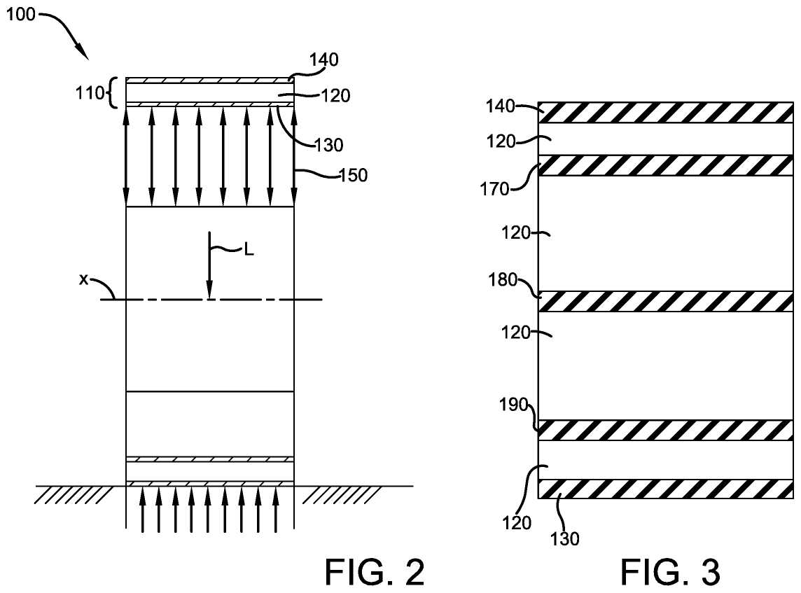

FIG. 3 shows another example shear band 210 having five reinforcement layers 130, 140, 170, 180, 190 surrounding four shear layers 120 (e.g., three reinforcement layers 170, 180, 190 added between the innermost and outermost reinforcement layers 130, 140.

The shear band 110 or 210 may provide a longitudinal bending stiffness during operation of the wheel/tire 100. For certain applications, it may be desirable to maintain the overall thickness—along the radial direction of shear band 110, 210 while simultaneously increasing its bending stiffness. For example, a designer may seek to maintain the overall diameter of the wheel/tire 100 and the shear beam thickness while increasing the bending stiffness of the shear band 110, 210 in order to change the performance characteristics of the wheel/tire. Conversely, for other applications, it may be desirable to decrease the thickness of shear band 110, 210 while maintaining the bending stiffness of the shear band and thus reduce mass.

Reference will now be made in detail to examples of the present invention with reference to FIGS. 1-4. Each example is provided by way of explanation of the present invention, and not meant as a limitation of the invention. For example, features illustrated or described as part of one example may be used with another example to yield still a third example. It is intended that the present invention include these and other modifications and variations. It should be noted that for the purposes of discussion, only half of the exemplary tire embodiments may be depicted in one or more of FIGS. 1-4. Reference numbers are used in the Figures solely to aid the reader in identifying the various elements and are not intended to introduce any limiting distinctions among the examples. Common or similar numbering for one example indicates a similar element in the other examples. One of ordinary skill in the art, using the teachings disclosed herein, may understand that the same or substantially similar features are repeated on both sides of the tire.

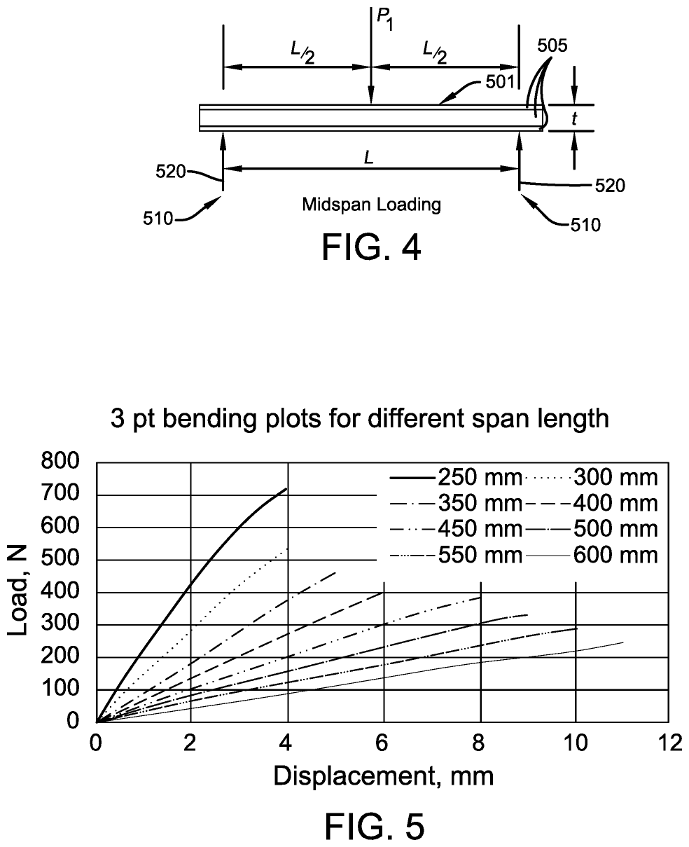

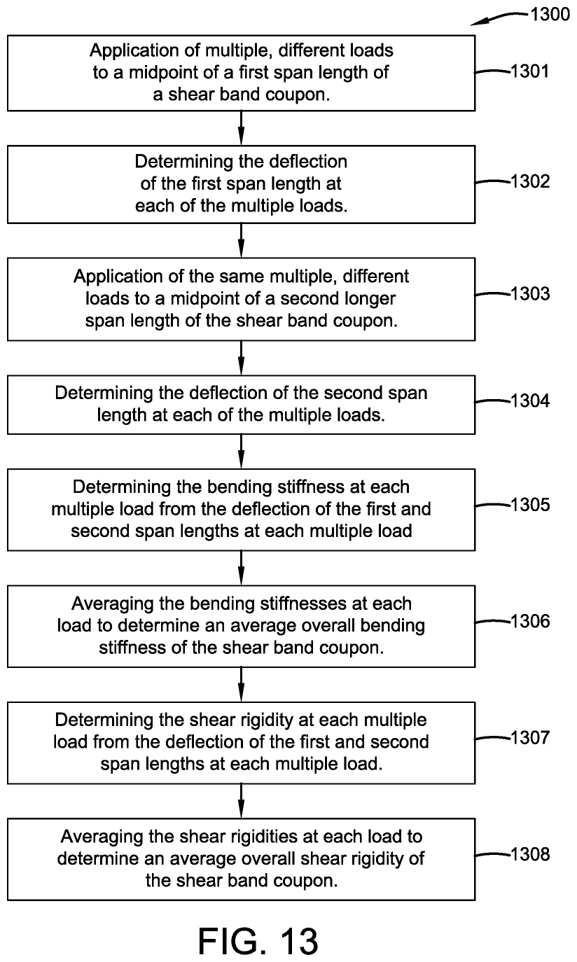

Another shear band 501 (FIG. 4) for use with the present invention may include layers of lightweight composite materials, replacing rubber and steel cords. To test, or validate, this shear band 501, the bending stiffness EI and shear rigidity GA of these composites may be determined, since these are two main characteristics dictating the functional behavior of the shear band 501. A system 1300 (FIG. 13) in accordance with the present invention may define/test a shear band, such as the shear band 501, and determine the bending stiffness EI and shear rigidity GA of the layers 505 accurately and efficiently.

As shown schematically in FIG. 4, the system 1300 may include a 3-point bend test. A fixture 510 may accommodate a long sandwich beam, or shear band coupon 501, having the proposed shear band structure for determining and evaluating EI and GA of the proposed shear band structure. The span length of the coupon 501 may be adjusted by adjusting support bars 520 of the fixture 510. The system 1300 may include the proposition that EI of the coupon 501 may depend on span length-to-thickness ratio (L/t). According to conventional sandwich beam theory, EI does not depend on geometry other than sandwich coupon width, core thickness, and facesheet thickness. Thus, this theory utilizes this relationship between EI and (L/t). A laser sensor with a resolution of 5μm to 8μm of displacement may determine the beam deflection under the load point of the coupon 501 in real time.

The 3-point bending system 1300 may characterize the flexural/bending and shear behavior of the coupon 501, such as flexural moduli, EI and GA, respectively. The system 1300 may be performed according to standard ASTM D7250. A standard crosshead displacement of 6 mm/min may be used with load and displacement data collected at a frequency of 10 Hz. The laser sensor may collect the displacement of the tensile fade underneath the loading point P₁ for better accuracy.

Each coupon 501 may be tested at different span lengths (distance between the support bars 520) (FIG. 4) starting from a longest possible span length (which may be ˜550 mm to 600 mm, depending on the length of the coupon) to a final 250 mm span length, such as at an interval of 50 mm. While tested, the applied forces for all the span lengths may be maintained sufficiently low to avoid failure and/or permanent deformation of the coupon 501.

The system 1300 of the present invention may characterize the flexural and shear behavior of the coupon 501, such as with a flexural modulus and a shear modulus, EI and GA, respectively. The characterization may be performed according to ASTM D7250. A standard crosshead displacement of 6 mm/min may be used. Load and displacement data may be collected at a frequency of 10 Hz. As described above, a laser sensor may collect the displacement data, or tensile fade, underneath the loading point for optimal accuracy. As shown in FIG. 4, one example layout for the system 1300 may include a 3-point bending configuration of the sandwich coupon 501.

As described above, each coupon 501 may be evaluated for different span lengths (distance between the support bars 520) starting from longest possible span length (which may be ˜550 mm to 600 mm depending on the coupon overall length) to a 250 mm span length at seven incremental intervals of ˜50 mm. The applied forces for each span length may be maintained sufficiently low to avoid failure and/or permanent deformations of the coupon 501.

Examples of constructions of the coupon 501 may include wire band facing sheets and a rubber compound core, entirely metal facing sheets and a rubber compound core, wire band facing sheets and a 3D spacer fabric core with or without a rubber layer at the sides. Example dimensions for the wire facing/rubber core coupons may be 610 mm×101.6 mm×12 mm. Example dimensions for the wire facing/3D spacer core coupons may also be 610 mm×101.6 mm×12 mm.

FIG. 5 shows example load-displacement plots of representative coupons obtained from the 3-point bend as a function of span length. Using this data, bending stiffness EI and shear rigidity GA of the coupons may be calculated. A long sandwich coupon (670 mm×38 mm×5 mm) of a full metal facing sheet and rubber core may be used, as a reference sample.

Three different systems may be used to calculate the bending stiffness EI and shear rigidity GA of the reference sample. Findings from these multiple systems may be used to justify the use of the system 1300 of the present invention.

First, an experimental system may be used to calculate only EI. Second, an analytical system may be used to calculate apparent EI and apparent GA. Third, the system 1300 of the present invention may be used to combine the above first and second systems to calculate EI and GA.

In the experimental system, the flexural modulus of the reference sample may use load-displacement data obtained from the 3-pt bending procedure and below equation (1) to calculate E (as shown in FIG. 5).

$$E = \frac{{mL}^{3}}{4 {bt}^{3}} \qquad ( 1 )$$

### Where,

E=Flexural modulus of elasticity of the composite layers, (MPa)
L=Support span, (mm)
b=Width of the reference sample, (mm)
t=Thickness of the reference sample, (mm)
m=Slope of the initial straight-line portion of the load deflection curve, (N/mm), as shown exemplarily in FIG. 5.

Bending stiffness EI may then be calculated by multiplying E by the moments of inertia I for this reference sample determined by equation (2) below.

$$I = \frac{{bt}^{3}}{12} \qquad ( 2 )$$

### Where,

I=Moment of inertia, (mm⁴)
b=Width of the reference sample, (mm)
t=Thickness of the reference sample, (mm)

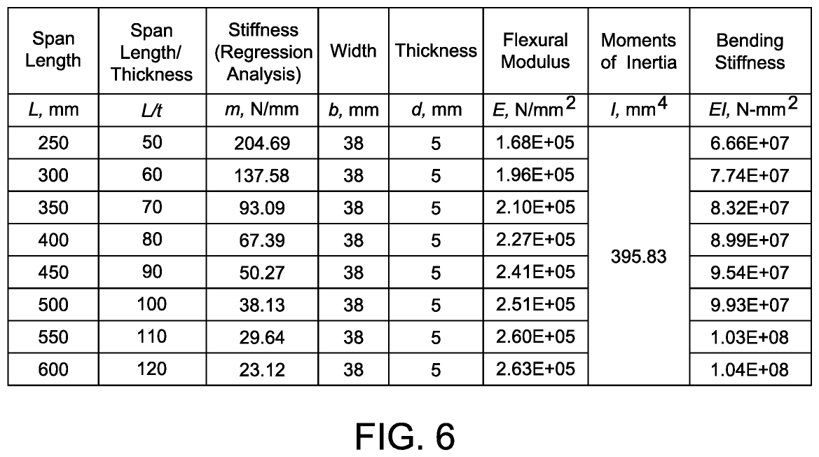

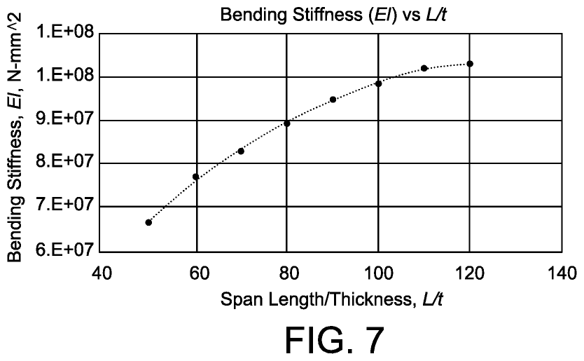

Example EI values for this system are shown in FIG. 6. From FIG. 6, it may be deduced that EI increases with an increase of L/t when plotted as a function of L/t, as in FIG. 7. As a result, it may be surmised that EI may reach a plateau region at L/t=120 (FIG. 7). Thus, this reference sample at the L/t value that may produce a theoretical EI through this 3-point bend system.

In the analytical system, a mid span deflection δ for the reference sample in the linear elastic region may be the sum of the flexural and shear deflections EI, GA, as shown in below equation (3)

$$δ = {δ}_{1} + {δ}_{2} = \frac{P {L}^{3}}{48 EI} + \frac{P L}{4 G A} \qquad ( 3 )$$

### Where,

δ=Mid span deflection of the reference sample the linear elastic region, (mm)
δ1=Deflection due to bending effect alone, (mm)
δ2=Deflection due to shear effect alone, (mm)
P=Peak load at mid span deflection, (N)
L=Span length, (mm)
G=Shear modulus of elasticity of the composite layers, (MPa)
Equation (3) may be rearranged to provide

$$\frac{δ}{P L} vs {L}^{2}$$

for the reverence sample.

$$\frac{δ}{P L} = \frac{{L}^{2}}{48 EI} + \frac{1}{4 G A} \qquad ( 4 )$$

If equation (4) is fitted by a linear law, the slope of

$$\frac{δ}{P L} vs {L}^{2}$$

provides a factor

$$\frac{1}{48 EI}$$

and an extrapolation to L=0 provides a factor

$$\frac{1}{4 G A} .$$

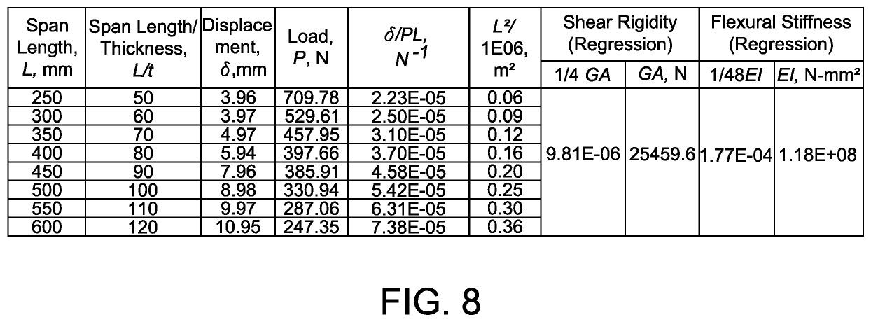

These may then calculate apparent EI and GA of the reference sample. Example apparent EI and apparent GA are shown in FIG. 8. A

$$\frac{δ}{P L} vs {L}^{2}$$

plot along with the linear fitted line describing the evolution of

$$\frac{δ}{P L} vs {L}^{2}$$

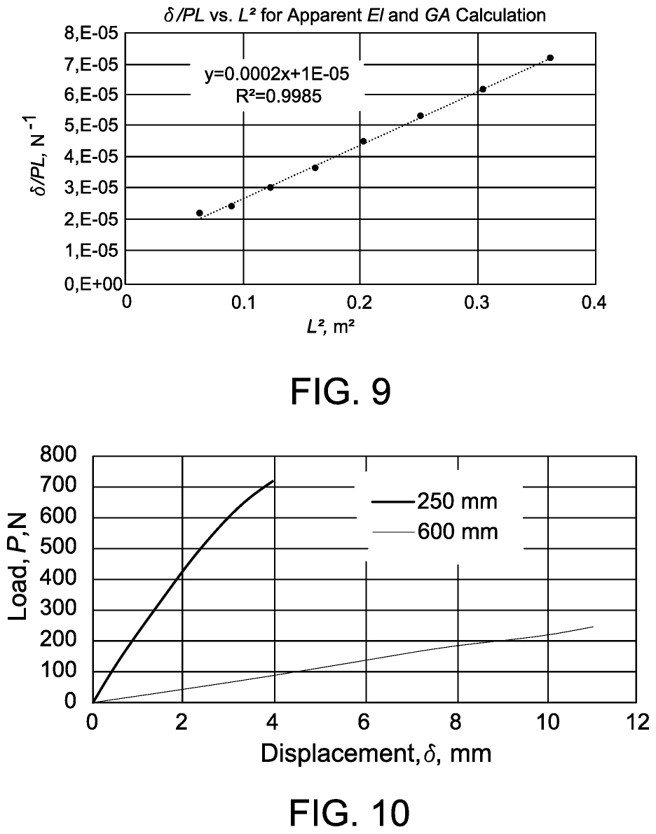

are shown in FIG. 9.

To calculate EI and GA using the system 1300 of the present invention, load-displacement data for only two span lengths may be used: a short span length of 250 mm and a long span length of 600 mm (See FIG. 10). This may thereby obtain load-deflection data for one test with relatively high shear deflection and one test with relatively high flexural deflection. If two short configurations or two long configurations are tested, measurement errors may be large relative to the difference in shear and flexural deflections between the two tests and may lead to significant errors in the calculated flexural and shear stiffnesses EI, GA.

EI and GA may be calculated using equations (5) and (6) below for a series of applied forces up to a lowest maximum applied force of the two loading configurations. Values may be calculated for a minimum of ten force levels evenly spaced over the force range. EI and GA may be calculated with the values determined at each force level. The result may be a set of stiffness values as a function of force level. Average EI and GA values may be calculated with values from each force level, which may be desired stiffness values.

$$\begin{matrix}EI = \frac{P 1 L {1}^{3}}{48 δ 1} \frac{( 1 \frac{L {2}^{2}}{L {1}^{2}} )}{( 1 \frac{P 1 L 1 δ 2}{P 2 L 2 δ 1} )} & ( 5 ) \\ GA = \frac{P 1 L 1}{4 δ 1} \frac{( \frac{L {1}^{2}}{L {2}^{2}} - 1 )}{( ( \frac{P 1 L {1}^{3} δ 2}{P 2 L {2}^{3} δ 1} ) - 1 )} & ( 6 )\end{matrix}$$

### Where,

P1=Total applied force (configuration # 1), N
L1=Support span length (configuration # 1), mm
δ1=Beam mid span deflection corresponding to force P1
P2=Total applied force (configuration # 2), N
L2=Support span length (configuration # 3), mm
δ2=Beam mid span deflection corresponding to force P2

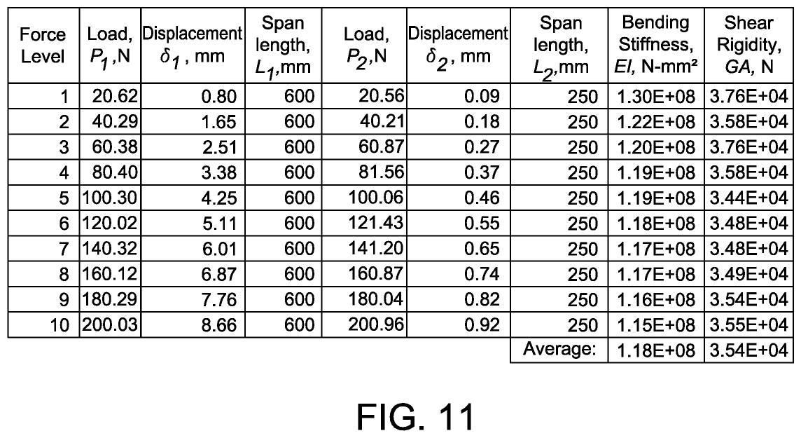

Individual and average EI and GA values using the system 1300 for two support span length configurations are shown in FIG. 11. The data may be calculated for ten force levels and the average EI and GA values may be 1.18 E+08 N-mm² and 35369 N, respectively.

The EI value from the experimental system may be 1.04 E+08 N-mm². The EI value from the analytical system may be 1.18 E+08 N-mm². The EI value from the system 1300 of the present invention may be 1.18 E+08 N-mm². From these, it may be seen that EI obtained using the three methods are comparable for this reference sample.

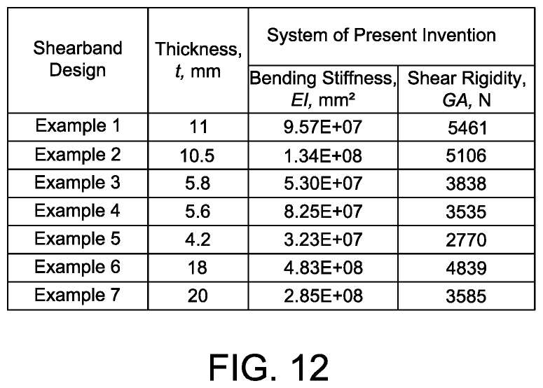

FIG. 12 shows EI and GA values obtained using the system 1300. Four coupons with rubber cores (Examples 1-4) and three coupons with 3D spacer fabric cores (Examples 5-7) were used. From the data presented in FIG. 12, it may be seen that EI increases when lightweight, low cost 3D spacer fabric w/expandable foam is used as a core material, instead of conventional rubber. GA remains within the comparable limits. Thus, if higher bending stiffness is a requirement, 3D spacer fabric core w/expandable foam may be a preferred design.

As shown in FIG. 13, the system 1300 may thus determine average values for bending stiffness and shear rigidity of a shear band coupon 501 over varying midpoint force levels (FIG. 4). The system 1300 may include application 1301 of multiple, different loads to a midpoint of a first span length of a shear band coupon 501, determining 1302 the deflection of the first span length at each of the multiple loads, application 1303 of the same multiple, different loads to a midpoint of a second longer span length of the shear band coupon 501, determining 1304 the deflection of the second span length at each of the multiple loads, determining 1305 the bending stiffness at each multiple load from the deflection of the first and second span lengths at each multiple load, averaging 1306 the bending stiffnesses at each load to determine an average overall bending stiffness of the shear band coupon 501, determining 1307 the shear rigidity at each multiple load from the deflection of the first and second span lengths at each multiple load, and averaging 1308 the shear rigidities at each load to determine an average overall shear rigidity of the shear band coupon 501.

The foregoing and other objects, features, and advantages of the present invention will be apparent from the above detailed descriptions of examples of the present invention, as illustrated in the accompanying drawings wherein like reference numbers represent like parts of the present invention.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A system for determining average values for bending stiffness and shear rigidity of a shear band coupon;
application of multiple, different loads to a midpoint of a first span length of the shear band coupon;
determining the deflection of the first span length at each of the multiple loads;
application of the same multiple, different loads to a midpoint of a second longer span length of the shear band coupon;
determining the deflection of the second span length at each of the multiple loads;
determining the bending stiffness at each multiple load from the deflection of the first and second span lengths at each multiple load;
averaging the bending stiffnesses at each load to determine an average overall bending stiffness of the shear band coupon;
determining the shear rigidity at each multiple load from the deflection of the first and second span lengths at each multiple load; and
averaging the shear rigidities at each load to determine an average overall shear rigidity of the shear band coupon.

2. The system as set forth in claim 1 wherein the shear band coupon has layers of lightweight composite materials.

3. The system as set forth in claim 1 further including a fixture accommodating the shear band coupon during load application.

4. The system as set forth in claim 1 further including a laser sensor for measuring the deflections of the first and second lengths under each of the multiple loads.

5. The system as set forth in claim 1 wherein the shear band coupon has wire band facing sheets and a rubber compound core.

6. The system as set forth in claim 1 wherein the shear band coupon has entirely metal facing sheets and a rubber compound core.

7. The system as set forth in claim 1 wherein the shear band coupon has wire band facing sheets and a 3D spacer fabric core with a rubber layer at sides of the shear band coupon.

8. The system as set forth in claim 1 wherein the shear band coupon has wire band facing sheets and a 3D spacer fabric core without a rubber layer at sides of the shear band coupon.

9. The system as set forth in claim 1 wherein the shear band coupon has a 610 mm length, a 102 mm width, and a 12 mm thickness.

10. The system as set forth in claim 1 wherein the shear band coupon has a 670 mm length, a 38 mm width, and a 5 mm thickness.

11. A fixture for determining average values for bending stiffness and shear rigidity of a shear band coupon, the fixture comprising:
two support bars for securing the shear band coupon, the support bars being adjustable to vary a distance from one support bar to the other support bar;
a device for applying a vertical load to a mid-point location on the shear band coupon equidistant from each support bar; and
a laser sensor for measuring the vertical deflection of the mid-point location wherein multiple, different loads are applied by the device to a midpoint of a first span length of the shear band coupon and a different second span length of the shear band coupon, deflections of the midpoint being used to determine an average overall bending stiffness of the shear band coupon and an average overall shear rigidity of the shear band coupon.

12. The fixture as set forth in claim 11 wherein the shear band coupon has layers of lightweight composite materials.

13. The fixture as set forth in claim 11 wherein the laser sensor measures the deflections of the first and second span lengths under each of the multiple loads.

14. The fixture as set forth in claim 11 wherein the shear band coupon has wire band facing sheets and a rubber compound core.

15. The fixture as set forth in claim 11 wherein the shear band coupon has entirely metal facing sheets and a rubber compound core.

16. The fixture as set forth in claim 11 wherein the shear band coupon has wire band facing sheets and a 3D spacer fabric core with a rubber layer at sides of the shear band coupon.

17. The fixture as set forth in claim 11 wherein the shear band coupon has wire band facing sheets and a 3D spacer fabric core without a rubber layer at sides of the shear band coupon.

18. The fixture as set forth in claim 11 wherein the shear band coupon has a 610 mm length, a 102 mm width, and a 12 mm thickness.

19. The fixture as set forth in claim 11 wherein the shear band coupon has a 670 mm length, a 38 mm width, and a 5 mm thickness.

20. The fixture as set forth in claim 11 wherein the first and second span lengths are determined by a first and a second distance between the support bars.
